(19) United States
(12) Patent Application Publication
(10) Pub. No.: US 2009/0174117 A1
(43) Pub. Date: Jul. 9, 2009

(54) METHOD FOR PRODUCING INVERSE OPALS HAVING ADJUSTABLE CHANNEL DIAMETERS

(76) Inventors: Holger Winkler, Darmstadt (DE); Goetz Peter Hellmann, Mainz (DE); Tilmann Eberhard Ruhl, Griesheim (DE); Peter Spahn, Hanau (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/296,686

(22) PCT Filed: Mar. 13, 2007
(86) PCT No.: PCT/EP2007/002177

§ 371 Date: Oct. 10, 2008

(30) Foreign Application Priority Data
Apr. 12, 2006 (DE) 10 2006 017 163.2

(51) Int. Cl. B29C 41/46; B29C 41/42

(52) U.S. Cl. 264/319; 264/334

(57) ABSTRACT

The invention relates to a process for the preparation of inverse opals having adjustable channel diameters. This is achieved by partial fusing of solid organic or inorganic spheres.

The invention relates to a process for the preparation of inverse opals having adjustable channel diameters.

Three-dimensional photonic structures are generally taken to mean systems which have a regular, three-dimensional modulation of the dielectric constants (and thus also of the refractive index). If the periodic modulation length corresponds approximately to the wavelength of (visible) light, the structure interacts with the light in the manner of a three-dimensional diffraction grating, which is evident from angle-dependent colour phenomena. An example of this is the naturally occurring precious stone opal, which consists of closest-packed silicon dioxide spheres and cavities in between which are filled with air or water. The inverse structure to this is thought to be formed by regular spherical cavities being arranged in closest packing in a solid material. An advantage of inverse structures of this type compared with the normal structures is the formation of photonic band gaps with dielectric constant contrasts which are already much lower (K. Busch et al. Phys. Rev. Letters E, 198, 50, 3896).

Inverse opals can be prepared by a template process by arranging monodisperse spheres in closest packing (see FIG. 1). The cavities between the spheres are filled with a further material, which, after removal of the spheres, remains behind as wall material of the inverse opal.

The spherical cavities of the inverse opal are interconnected by channels. The channels are formed by the points of contact of the spheres of the template structure.

The primary building blocks used to construct inverse opals are uniform colloidal spheres (point 1 in FIG. 1). Besides further characteristics, the spheres must obey the narrowest possible size distribution (5% size deviation is tolerable). Particular preference is given in accordance with the invention to monodisperse PMMA spheres having a diameter in the submicron range produced by aqueous emulsion polymerisation. In the second step, the uniform colloidal spheres, after isolation and centrifugation or sedimentation, are arranged in a three-dimensional regular opal structure (point 2 in FIG. 1). This template structure corresponds to closest spherical packing, i.e. 74% of the space is filled with spheres and 26% of the space is empty (interspaces or cavities). It can then be solidified by conditioning. In the next working step (point 3 in FIG. 1), the cavities of the template are filled with a substance which forms the walls of the later inverse opal. The substance can be, for example, a solution of a precursor (for example tetraethoxysilane). The precursor is then solidified by calcination, and the template spheres are likewise removed by calcination (point 4 in FIG. 1). This is possible if the spheres are polymers and the precursor is capable, for example, of carrying out a sol-gel reaction (transformation of, for example, silicic esters into SiO₂). After complete calcination, a replica of the template, the so-called inverse opal, is obtained.

Many such processes, which can be used for the production of cavity structures for use in accordance with the present invention, are known in the literature (for example S. G. Romanov et al., Handbook of Nanostructured Materials and Nanotechnology, Vol. 4, 2000, 231 ff.; V. Colvin et al. Adv. Mater. 2001, 13, 180; De La Rue et al. Synth. Metals, 2001, 116, 469; M. Martinelli et al. Optical Mater. 2001, 17, 11; A. Stein et al. Science, 1998, 281, 538). Core/shell particles whose shell forms a matrix and whose core is essentially solid and has an essentially monodisperse size distribution are described, for example, in DE-A-10145450. The use of core/shell particles whose shell forms a matrix and whose core is essentially solid and has an essentially monodisperse size distribution as templates for the production of inverse opal structures and a process for the production of inverse opal-like structures using such core/shell particles are described in International Patent Application WO 2004/031102. The mouldings described having homogeneous, regularly arranged cavities preferably have walls of metal oxides or of elastomers. The mouldings described are consequently either hard and brittle or exhibit an elastomeric character.

The removal of the regularly arranged template cores can be carried out by various methods. If the cores consist of suitable inorganic materials, such as, for example, titanium oxides, silicon oxides, aluminium oxides, zinc oxides and/or mixtures thereof, these can be removed by etching. Silicon dioxide cores, for example, can preferably be removed using HF, in particular dilute HF solution.

If the cores in the core/shell particles are built up from a material which can be degraded by means of UV radiation, preferably a UV-degradable organic polymer, the cores are removed by UV irradiation. In this procedure too, it may in turn be preferred for crosslinking of the shell to be carried out before or after removal of the cores. Suitable core materials are then, in particular, poly(tert-butyl methacrylate), poly(methyl methacrylate), poly(n-butyl methacrylate) or copolymers which contain one of these polymers.

It may furthermore be particularly preferred for the degradable core to be thermally degradable and to consist of polymers which are either thermally depolymerisable, i.e. decompose into their monomers on exposure to heat, or for the core to consist of polymers which on degradation decompose into low-molecular-weight constituents which are different from the monomers, Suitable polymers are given, for example, in the table “Thermal Degradation of Polymers” in Brandrup, J. (Ed.): Polymer Handbook. Chichester Wiley 1966, pp. V-6-V-10, where all polymers which give volatile degradation products are suitable. The contents of this table are expressly incorporated into the disclosure content of the present application.

Preference is given here to the use of poly(styrene) and derivatives, such as poly(α-methylstyrene) or poly(styrene) derivatives which carry substituents on the aromatic ring, such as, in particular, partially or perfluorinated derivatives, poly(acrylate) and poly(methacrylate) derivatives and esters thereof particularly preferably poly(methyl methacrylate) or poly(cyclohexyl methacrylate), or copolymers of these polymers with other degradable polymers, such as, preferably, styrene-ethyl acrylate copolymers or methyl methacrylate-ethyl acrylate copolymers, and polyolefins, polyolefin oxides, polyethylene terephthalate, polyformaldehyde, polyamides, polyvinyl acetate, polyvinyl chloride or polyvinyl alcohol.

Regarding the description of the resultant mouldings and the processes for the production of mouldings, reference is made to WO 2004/031102, the disclosure content of which is expressly incorporated into the present application.

In order to load inverse opals with relatively large molecules or particles, an increase in the channel diameters is necessary.

In addition, an enlargement of the channels enables setting of the optical properties of the inverse opal.

Besides on the diameter of the cavities, the reflection wavelength of the inverse opal is also dependent on the effective refractive index, which represents the average, weighted in accordance with volume proportions, of the refractive index of the wall material and the material in the pore system. The effective refractive index can be adjusted through the materials and through the volume proportions. The latter can be influenced by the variability of the channel diameters.

Surprisingly, a suitable process for the preparation of inverse opals has now been found in which the channel diameters can be adjusted by partial fusing of solid spheres.

The present invention therefore relates to a process for the preparation of inverse opals having adjustable channel diameters, characterised in that
a) template spheres are arranged regularly,
b) the template spheres subsequently partially fuse at elevated temperatures due to an increase in the contact area of the spheres,
c) the sphere interspaces are impregnated with a precursor of the wall material,
d) the wall material is formed and the template spheres are removed.

The channel diameters can be increased by increasing the contact areas of the spheres (see FIG. 2). This can be achieved in various ways:
1) Templates consisting of closest-packed solid polymer spheres can be partially fused into one another by gentle heating above the softening temperature, leaving interspaces in the spherical packing which can be filled with the wall former material. After solidification of the wall material and removal of the template spheres, an inverse opal having enlarged channels remains.
2) In the case of a template consisting of inorganic spheres, an analogous procedure can be followed by partially sintering the template spheres by the influence of temperature at 700 to 900° C.
3) If the template-forming spheres are built up from core/shell particles consisting of a hard core and a soft shell, the channel diameter can be set depending on the size of the shell. The thicker the shell, the larger the channel diameter becomes. The shell thickness in accordance with the invention is 10 to 0.5% of the sphere diameter.

As already mentioned above, the template spheres can consist of inorganic or polymeric material or core/shell particles. Particular preference is given in accordance with the invention to the use of template spheres of PMMA. The softening temperatures necessary for the partial fusing of the polymeric spheres are known to the person skilled in the art (see glass transition temperatures from Polymer Handbook, 1999, John Wiley & Sons, Chap. 6, p. 198).

In the case of the use of PMMA spheres, a temperature of 130 to 160° C. for 10 to 60 minutes is preferred in accordance with the invention, after the drying operation lasting several hours, in order to increase the channel diameters by partial fusing of the spheres. A temperature of 140 to 150° C. for about 30 minutes is particularly preferred here.

It is particularly preferred in accordance with the invention for the average diameter of the cavities in the inverse opal to be in the range about 100-700 nm, preferably in the range 150-500 nm.

The following example is intended to illustrate the present invention. However, it should in no way be regarded as limiting. All compounds or components which can be used in the compositions are either known and commercially available or can be synthesised by known methods.

### EXAMPLES

### Example

### 1. Production of PMMA Spheres

A 2 l jacketed stirred vessel with anchor stirrer (stirrer speed 300 rpm) and reflux condenser is charged with 1260 ml of deionised water and 236 ml of methyl methacrylate, and the mixture is heated to 80° C. A weak stream of nitrogen, which is able to escape via an overpressure valve on the reflux condenser, is passed into the mixture for 1 h, before 1.18 g of azodiisobutyramidine dihydrochloride as free-radical initiator are added. The formation of latex particles is evident from the clouding which immediately sets in. The polymerisation reaction is monitored thermally, with a slight increase in the temperature due to the enthalpy of reaction being observed. After 2 hours, the temperature has re-stabilised at 80° C., indicating the end of the reaction. After cooling, the mixture is filtered through glass wool. Investigation of the dried dispersion using the SEM shows uniform, spherical particles having an average diameter of 317 nm.

### 2. Arrangement of the PMMA Spheres in the Opal Template

10 g of the PMMA sphere dispersion from 1) are transferred into centrifuge tubes and centrifuged at 3000 rpm for 8 h. The supernatant liquid is decanted off, distilled water is added again, and the mixture is centrifuged again at 3000 rpm for 8 h. After careful decanting off, the residue exhibits opalescent colours, which is an indication that the residue has the structure of an opal. The residue is carefully removed from the centrifuge tube and placed in a drying cabinet.
2 a. The residue is then divided into two portions; one portion (a) is dried at 100° C. for a period of 4 hours.
2 b. The second portion (b) is firstly dried at 100° C. for a period of 4 hours. The temperature is then increased to the softening temperature of PMMA (140° C.-150° C.) and left for a period of 30 min, before the sample is cooled.
   3. Infiltration of the Opal Template with the Wall Former and Thermal Conversion into the Inverse Opal

10 ml of a precursor solution are prepared by mixing 8 g of ethanol, 1 g of tetraethoxysilane and 1 g of 2 molar aqueous hydrochloric acid (solution A). The solution is stirred overnight at room temperature. In each case, 5 ml of this precursor solution are added dropwise to the opal template from 2 a and 2 b. The impregnated opal templates are dried at 80° C. in a drying cabinet and then calcined at 600° C., giving two inverse opal samples having different channel diameters (see FIG. 3).

### INDEX OF FIGURES

FIG. 1: Scheme of the preparation of an inverse opal by means of the template process

FIG. 2: The channels which interconnect the spherical pores of the inverse opal are formed by points of contact of the template spheres (far left). By increasing the contact area of the spheres by partial fusing of solid spheres (centre) or by overlapping soft shells of core/shell particles (far right), the diameter of the resultant channels is increased.

FIG. 3: Shows two SEM photomicrographs of inverse opals. On the left the inverse opal prepared from template 2 b (see example); on the right the inverse opal prepared from template 2 a. The inverse opal shown on the left has significantly larger channel diameters than that shown on the right.

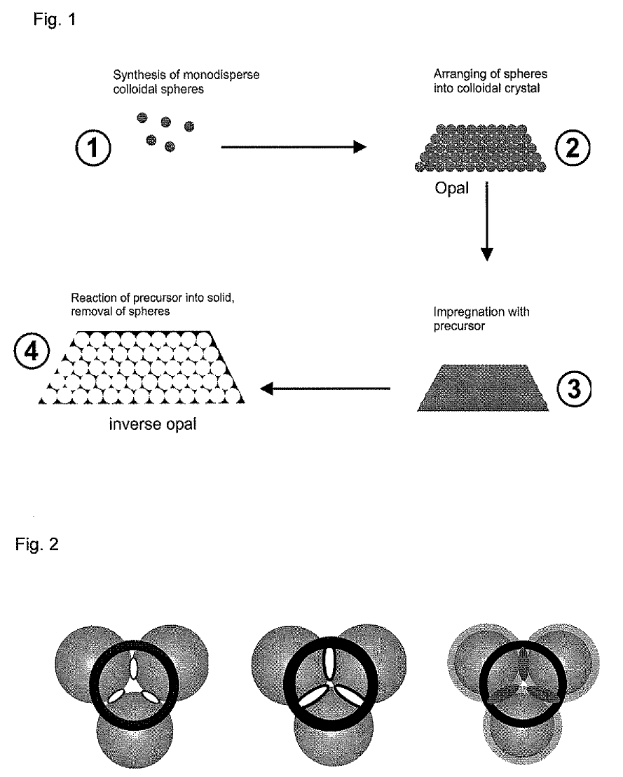

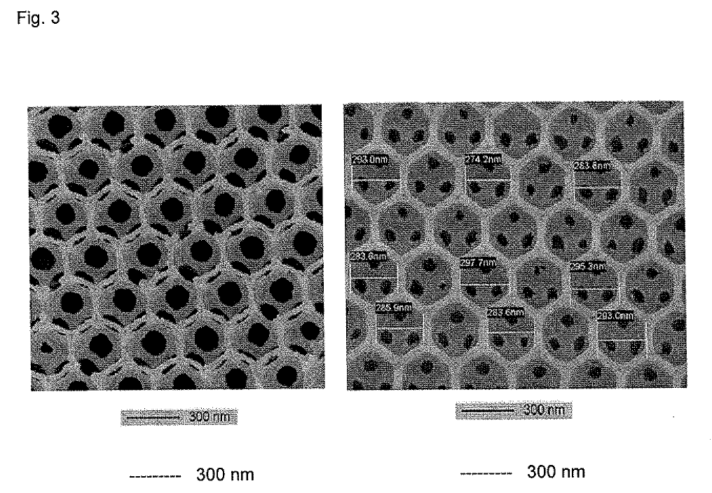

1. Process for the preparation of inverse opals having adjustable channel diameters, characterised in that
a) template spheres are arranged regularly,
b) the template spheres subsequently partially fuse at elevated temperatures due to an increase in the contact area of the spheres,
c) the sphere interspaces are impregnated with a precursor of the wall material,
d) the wall material is formed and the template spheres are removed.

2. Process according to claim 1, characterised in that the template spheres employed are polyacrylates, polystyrene and/or derivatives thereof and mixtures thereof or inorganic materials, such as titanium oxides, silicon oxides, aluminium oxides, zinc oxides and/or mixtures thereof.

3. Process according to claim 1, characterised in that the temperature selected in step b) is 90 to 150° C. for several hours.

4. Process according to claim 1, characterised in that the template spheres consist of PMMA.

5. Process according to claim 1, characterised in that the temperature in step b) is between 130 and 160° C. for 10 to 60 min.

6. Process according to claim 1, characterised in that the cavities of the inverse opal have a diameter in the range from 100 to 700 nm.
